(19) United States
(12) Patent Application Publication
(10) Pub. No.: US 2005/0184261 A1
(43) Pub. Date: Aug. 25, 2005

(54) Diaphragm for pilot valve

(76) Inventor: Yuval Stern, Nes Ziyonna (IL)

Correspondence Address: NATH & ASSOCIATES, 1030 15th STREET, NW, 6TH FLOOR, WASHINGTON, DC, 20005, US

(21) Appl. No.: 10/783,039

(22) Filed: Feb. 23, 2004

(51) Int. Cl. F16K 31/12

(52) U.S. Cl. 251/30.03

(57) ABSTRACT

An integral flexible diaphragm for a valve of the pilot type comprising a housing with a flow chamber and a control chamber connected by a pilot channel, and a control member for closing the pilot channel. The diaphragm separates the flow chamber from the control chamber and is disposed opposite a valve seat to control the flow through the valve. The diaphragm has a peripheral annular part and a central part both tightly fixed to the housing, and an intermediate annular part movable to close the valve seat. The pilot channel of the valve is obtained through the central part, so that a travel distance of the control member is independent of a travel distance of the intermediate annular part for closing the valve seat.

### FIELD OF THE INVENTION

This invention relates to diaphragms for valves of the pilot type, in particular to valves with a fixed pilot channel.

### BACKGROUND OF THE INVENTION

A valve of the pilot type, for example a solenoid-controlled valve, normally comprises a housing with an inlet port, an outlet port and an internal cavity, a flexible diaphragm dividing the cavity into a flow chamber and control chamber, and a solenoid with movable armature (plunger). The inlet port is in constant fluid communication with the flow chamber, while the outlet port is in fluid communication with the flow chamber via a valve seat formed in the housing opposite the diaphragm and closable by displacement of the diaphragm. The valve has a bleed channel connecting the flow chamber and the control chamber, and a pilot channel connecting the outlet port with the control chamber and closable by the armature. The bleed channel is typically obtained through the diaphragm.

The solenoid valve may operate as a stop valve between a high-pressure fluid source connected to the inlet port and a low-pressure sink connected to the outlet port. In a closed position of the valve, the diaphragm is lowered onto the valve seat, thereby isolating the outlet port from the flow chamber, while the plunger seals the pilot channel. Due to the communication through the bleed channel, the pressure in the control chamber is equal to the high inlet pressure in the flow chamber. However, the diaphragm area exposed to the high pressure in the control chamber is greater than the area facing the same high pressure in the flow chamber, so that the resulting force urges the diaphragm against the valve seat keeping the valve closed.

By switching the solenoid, the plunger is lifted off the pilot channel. The control chamber is thus connected to the low-pressure outlet port and the pressure therein falls. The resulting force on the diaphragm changes direction and the diaphragm lifts off the valve seat, thereby opening the valve. By another switching of the solenoid, the plunger again closes the pilot channel. As the communication with the low-pressure outlet is interrupted, the pressure in the control chamber builds up and the diaphragm lowers onto the valve seat closing the valve. Thus, significant flow rates may be controlled by a low-power solenoid valve.

In a conventional solenoid valve, for example as described in U.S. Pat. No. 4,787,411, the diaphragm has in its center a thicker part or an attached solid body adapted to close the valve seat and accommodating the pilot channel. In such a valve, the travel of the plunger to close or open the pilot channel is longer than the travel of the diaphragm to close or open the valve seat. However, while a large travel of the diaphragm is necessary for passing fluid via the flow chamber and the valve seat with less hydraulic losses, only minimal plunger travel is necessary for opening the pilot channel to change the pressure in the control chamber.

In other designs of solenoid valves, for example in U.S. Pat. No. 5,996,965, the pilot channel is obtained through the housing and is not movable. Thus, the travel of the plunger to close the pilot channel is not dependent on the travel of the diaphragm and may be made significantly shorter to save the operation power of the solenoid.

EP 0051517 describes a solenoid valve of the pilot type where the diaphragm has an attached solid body in its center adapted to close the valve seat, similarly to U.S. Pat. No. 4,787,411. The pilot channel is also obtained through the solid body but includes two parts. One part is an axial bore in the solid body while the second part is a tubular member fixed to the housing and sliding like telescope in the axial bore. The fluid tightness of the pilot channel is maintained by a bellows sleeve sealed with one end to the solid body and with the other end to the tubular member. Thus, the solenoid plunger travel can be minimized while the pilot channel is separated from the housing.

### SUMMARY OF THE INVENTION

In accordance with the present invention, in a valve of the pilot type comprising a housing with a flow chamber and a control chamber, the housing further having an inlet port in constant communication with the flow chamber, an outlet port in communication with the flow chamber via a valve seat formed in the housing, the valve further comprising a pilot channel connecting the outlet port to the control chamber and closeable by a movable control member, there is provided an integral flexible diaphragm separating said flow chamber from said control chamber and disposed opposite said valve seat. The diaphragm has a peripheral annular part and a central part both tightly fixable to the housing, and an intermediate annular part movable to close the valve seat, the pilot channel being obtained through the central part.

With the above design of the diaphragm, travel distance of the movable control member for closing the pilot channel is independent of the travel distance of the intermediate annular part for closing the valve seat.

The intermediate annular part of the diaphragm comprises an internal flexible ring, an external flexible ring, and a valve ring therebetween constituting one piece of material, such that the travel distance for closing the valve seat is provided by deformation of the two flexible rings while the valve ring is adapted to abut and seal the valve seat. The valve ring is preferably made of relatively thicker or harder material. One or both flexible rings may have a wave-like sectional profile.

In one embodiment, the central part of the diaphragm is fixed to the housing by means of a hard-material member tightly inserted in an orifice in the central part of the diaphragm and accommodating the pilot channel. The hard-material member may be made, inter alia, of one of the following: metal, metal alloy, polymer, rubber, and composite material.

The integral flexible diaphragm may have a bleed channel connecting the flow chamber to the control chamber and obtained through said intermediate annular part. The bleed channel may be formed in a member made of hard material and tightly sealed to an opening in the diaphragm.

In another embodiment, the central part is made of substantially the same material as the central part. The pilot channel has a pilot seat facing the movable armature, which may constitute an integral part of the diaphragm or may be formed as a hard-material part tightly mounted to the diaphragm.

If the housing is assembled from two or more parts, the diaphragm may be such that the peripheral annular part and the central part thereof can be simultaneously tightly fixed to the housing when the parts thereof are tightened to each other.

The diaphragm of the present invention provides for minimal travel distance of the control member, such as a solenoid plunger, in a valve which may be of rather simplified construction. The diaphragm may be produced as a single member or may be assembled of minimal number of pieces, for example two pieces. The mounting and dismounting of the diaphragm in the valve housing may be a simple one-step operation. The valve itself may be made more compact, light, cheap and energy-saving.

The diaphragm can be used in solenoid pilot valves, as well as in other types of pilot valves, such as pneumatically-controlled pilot valves.

### BRIEF DESCRIPTION OF THE DRAWINGS

In order to understand the invention and to see how it may be carried out in practice, preferred embodiments will now be described, by way of non-limiting examples only, with reference to the accompanying drawings, in which:

FIG. 1 is a sectional elevation of a solenoid valve with a diaphragm in accordance with the present invention, in open position;

FIG. 2 shows the electromagnetic valve of FIG. 1 in closed position;

FIG. 3 is a sectional elevation of a solenoid valve with a single-piece diaphragm in accordance with another embodiment of the present invention;

FIG. 4 is an exploded view of the solenoid valve of FIG. 3;

FIG. 5 is an axial view of the diaphragm shown in FIGS. 3 and 4; and

FIGS. 6 to 8 are partial sectional views of pilot valves with further embodiments of the diaphragm of the present invention.

### DETAILED DESCRIPTION OF THE INVENTION

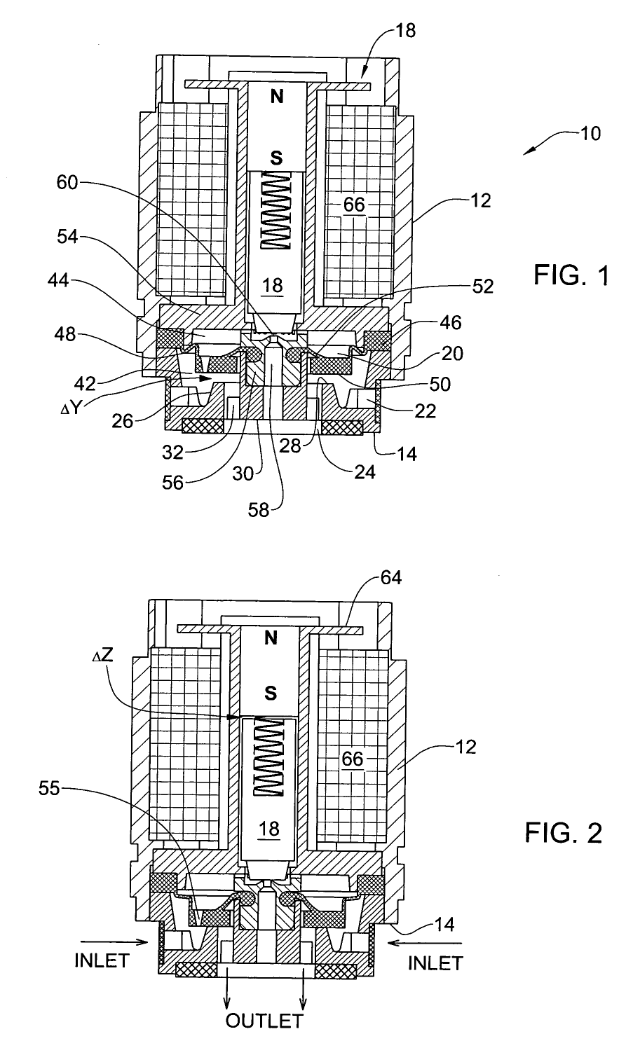

With reference to FIGS. 1 and 2, a solenoid valve 10 of the pilot type comprises a housing 12 with a threaded lid 14, a solenoid 16 with movable plunger 18, and a flexible diaphragm 20, in accordance with the present invention.

The housing 12 has an inlet port 22 (at the lid 14) and an outlet port 24. At the inner side of the lid 14, there is a protruding annular rim 26 defining an internal end of the outlet port 24 with a machined edge constituting a valve seat 28. A support 30 is disposed at the axis of the lid 14, in the middle of the outlet port 24, and is connected thereto by three or four bridges 32. The lid 14 is assembled to the housing 12 so as to define an internal cavity in communication with the inlet port 22 and the outlet port 24. The lid also tightly fixes the diaphragm 20 at its periphery and at its center, as will be explained below.

With reference also to FIG. 5, the diaphragm 20 is generally a resilient disk disposed across the internal cavity of the housing 12 and dividing it into a flow chamber 42 and control chamber 44, so that the inlet port 22 and the outlet port 24 are in communication with the flow chamber. The diaphragm 20 comprises an outer ring 46, a first thin corrugated ring 48, a thick valve ring 50 for sealing the valve seat 28, a second thin ring 52, and an internal annular lip 54. The outer ring 6 is restrained between the housing 12 and the lid 14. In the diaphragm center, here is an adapter 56 with an outer notch tightly accommodating the lip 54. The adapter 56, together with the annular lip 54 is urged to the housing 12 by means of the support 30, so that the central part of the diaphragm 20 is also fixed to the housing 12. The resilience of the thin rings 48 and 52 allows the valve ring 50 to be moved to or off the valve seat 28 by a travel distance ΔY.

The adapter 56 has an axial pilot channel 58 connecting the control chamber 44 to the outlet port 24. The pilot channel 58 is formed as an axial bore in the adapter 56, with a nozzle 60 at the side of the control chamber 44. An off-center bleeding channel 55 across the diaphragm 20 connects the flow chamber 42 to the control chamber 44.

The solenoid 16 comprises a tubular base 64 coaxial with the housing 12 and adjacent to the control chamber 44, a wire coil 66 wound around the base 64, and a permanent magnet 68. The plunger 18 is slidingly disposed in the tubular base 64 opposite the nozzle 60. The plunger 18 can be moved by an axial travel distance AZ between the permanent magnet 68 and the nozzle 60.

The solenoid valve 10 operates in a manner known per se in the art, as described above in the Background. It will be appreciated that the travel ΔZ for closing the pilot channel is independent of the travel ΔY for closing of the valve. Therefore, the travel ΔZ can be minimized for achieving lower power consumption of the solenoid and shorter response time.

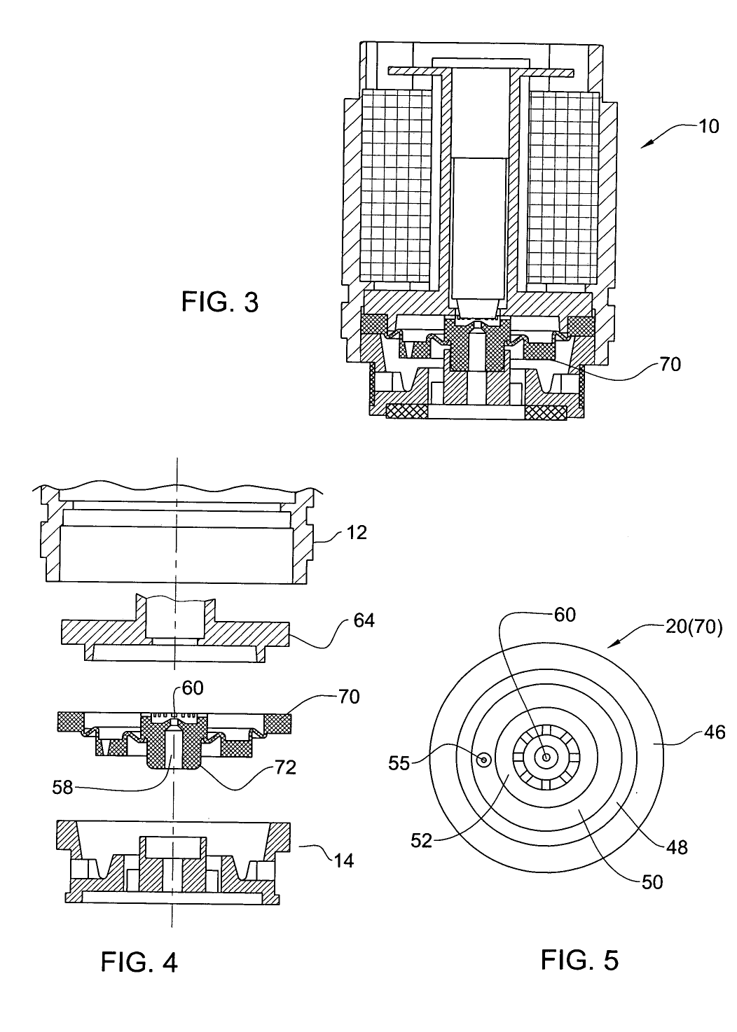

Another embodiment of the present invention is shown in FIGS. 3-5. A diaphragm 70 in accordance with this embodiment may be manufactured as a single-piece disk where the central part 72 is made thicker to provide better fixation to the housing. The pilot channel 58 with the nozzle 60 is formed in the body of the diaphragm.

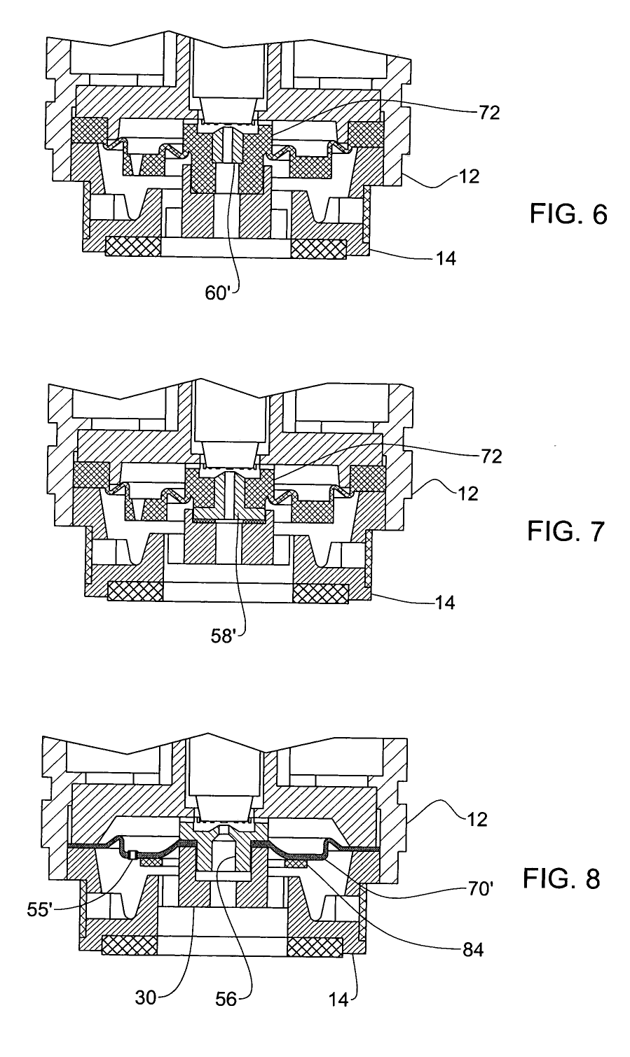

In further embodiments, various portions of the central part are manufactured of hard materials such as metal, metal alloys, polymer, rubber, and composites and integrated with the resilient diaphragm during its extrusion or curing. Thus, FIG. 6 shows a nozzle 60′ made of hard material as a separate member and integrated in the central part 72. Alternatively, as shown in FIG. 7, the whole pilot channel may be formed in a hard-material member 58′ integrated in the central part 72. Also, a diaphragm 70′ may be manufactured from one piece of thin flexible material with a rigid valve-sealing ring 84 bonded to it, as shown in FIG. 8. The bleed channel may be also formed as a member of hard material 55′ tightly fitted to an opening in the diaphragm.

1. In a valve of the pilot type comprising a housing with a flow chamber and a control chamber; said housing further having an inlet port in constant communication with said flow chamber, an outlet port in communication with said flow chamber via a valve seat formed in the housing, said valve further comprising a pilot channel connecting said outlet port to said control chamber and closeable by a movable control member,
an integral flexible diaphragm separating said flow chamber from said control chamber and disposed opposite said valve seat, wherein said diaphragm has a peripheral annular part and a central part both tightly fixable to the housing, and an intermediate annular part movable to close said valve seat, said pilot channel being obtained through said central part.

2. The integral flexible diaphragm of claim 1, wherein said intermediate annular part comprises an internal flexible ring, an external flexible ring, and a valve ring therebetween constituting one piece of material, for closing said valve seat.

3. The integral flexible diaphragm of claim 2, wherein at least one of said two flexible rings has wave-like sectional profile.

4. The integral flexible diaphragm of claim 2, further comprising a relatively rigid ring tightly fitted to said valve ring thereby adapting the latter to abut said valve seat.

5. The integral flexible diaphragm of claim 1, wherein said central part is fixable to the housing by means of a hard-material member tightly inserted in an orifice in said central part and accommodating said pilot channel.

6. The integral flexible diaphragm of claim 5, wherein said hard-material member is made of at least one of the following: metal, metal alloy, polymer, rubber, and composite material

7. The integral flexible diaphragm of claim 1, wherein a bleed channel connecting said flow chamber to said control chamber is obtained through said intermediate annular part.

8. The integral flexible diaphragm of claim 1, wherein a bleed channel connecting said flow chamber to said control chamber is formed in a member made of hard material and tightly sealed to an opening in said diaphragm.

9. The integral flexible diaphragm of claim 1, wherein said central part is made as one piece of material with said intermediate annular part.

10. The integral flexible diaphragm of claim 9, wherein said pilot channel has a pilot seat adapted to face said movable control member, said pilot seat constituting integral part of said central part.

11. The integral flexible diaphragm of claim 8, wherein said pilot channel has a pilot seat adapted to face said movable control member, said pilot seat being formed as a hard-material part tightly mounted to said central part.

12. The integral flexible diaphragm of claim 1, wherein said housing is assembled from two or more parts and said diaphragm is such that said peripheral annular part and said central part thereof can be tightly fixed to said housing when said parts thereof are tightened to each other.

13. A valve of the pilot type comprising a housing with a flow chamber and a control chamber; said housing further having an inlet port in constant communication with said flow chamber, an outlet port in communication with said flow chamber via a valve seat formed in the housing, said valve further comprising an integral flexible diaphragm separating said flow chamber from said control chamber and disposed opposite said valve seat, and a pilot channel connecting said outlet port to said control chamber and closeable by a movable control member,
wherein said diaphragm has a peripheral annular part and a central part both tightly fixed to the housing, and an intermediate annular part movable to close said valve seat, said pilot channel being obtained through said central part.

14. The valve of claim 13, wherein said moveable control member is driven by a solenoid.

15. The valve of claim 13, wherein said moveable control member is driven pneumatically.
